(19) United States
(12) Patent Application Publication
(10) Pub. No.: US 2011/0047271 A1
(43) Pub. Date: Feb. 24, 2011

(54) METHOD AND SYSTEM FOR ALLOCATING RESOURCES

(75) Inventors: Gregoire Guibe, Paris (FR); Pablo Diaz, Paris (FR)

Correspondence Address: LOWE HAUPTMAN HAM & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/294,466

(22) PCT Filed: Mar. 26, 2007
(86) PCT No.: PCT/EP2007/052880

§ 371 Date: Nov. 9, 2010

(30) Foreign Application Priority Data
Mar. 27, 2006 (FR) 06 02649

(51) Int. Cl. G06F 15/173

(52) U.S. Cl. 709/226

(57) ABSTRACT

A method and system is disclosed for allocating resources in a communication network including several nodes capable of transmitting and receiving data and a central node capable of allocating resources. At least one node transmits one or more requests (R_{nqt}) to the central node with each request (R_{nqt}) being associated with a requirement (qᵢ). The central node allocates a lifetime (Δt_{qi}) to each request (R_{nqt}) according to the requirement (qᵢ) of the request. Each request (R_{nqt}) is scheduled in a queue according to the lifetime (Δt_{qi}) and the moment of receipt (t_{R}) of the request.

The invention relates to a method and a system for allocating resources. It applies in a communications network, particularly to communications in a wireless network.

The present invention finds its application in the field of wireless networks operating on the principle of Time Division Multiple Access or “TDMA”.

Amongst other things, and in a nonexclusive manner, it applies to the communications in an “ad hoc” distributed network and in particular in a network of the ad hoc type whose data has an urgently nature.

There are several techniques making it possible to share resources between the various users or services of a network. Frequency-Division Multiple Access or FDMA, for example, consists in dividing the bandwidth of a communication bearer into distinct frequency bands. Time division multiple access (TDMA) consists in dividing the time into small intervals or time windows sometimes called “slots” and in allocating a given time slot to each service or user. The users then transmit data on different time slots.

In an ad hoc network, operating on the TDMA principle, a station or a network node plays the role of network coordinator by allocating the transmission moments to the various users or services according to their requirements. This node may be called the central node, master node, “scheduler” or “cluster head”. Each network node, for example, may be associated with a user or a service. Ad hoc networks have the advantage of allowing high bit rate transfers and the possibility of interconnection with existing structures.

The use of this type of network requires very precise and fair allocation management between the users or the services. In addition, in such a network, the data to be transmitted do not all have the same requirements. For example, voice “times out” rapidly (in approximately 250 ms) and the transmission delays must therefore be minimized. On the other hand, the loss of a few packets of this data type does not significantly harm the quality of transmission. On the contrary, for the background traffic class which corresponds to secondary traffic with no real time constraints, such as for example email, the data may be subjected to delays but it is imperative that all the packets are transmitted. The requirements expressed by the nodes may be associated with the quality of service (QoS) of the associated service. The quality of service is specified by QoS parameters expressing features provided for data transfer such as the bit rate, transit time, precision and reliability.

Various queue management methods for the allocation of resources are currently known in the prior art, for example:
First in First out or “FIFO”;
static scheduling with absolute priorities or “priority queuing”;
fair scheduling of packets according to the detected flows or “weighted fair queuing” or “flow based queuing”;
scheduling according to a determined traffic class or “class-based queuing or CBQ”. The classes may be based on a number of parameters such as the priority, interface or originating program; and
static scheduling with relative priorities computed on a bandwidth guarantee request or “Custom queuing”.

US patent 2003/0198204 discloses a method and system for allocating resources for the transmission of data subjected to quality of service (QoS) constraints. This system makes it possible to schedule traffic initially based on static allocation parameters then, by adapting this order thanks to compensation coefficients computed according to the flow, the weighting time in the queue and the priority. This approach is well suited to traffic of the isochronous type such as video. However, in the case of non deterministic sources (voice for example depends on speakers), compensation does not seem sufficient to make the approach usable. The adaptation is carried out little by little and cannot respond immediately to greatly variable traffic.

Furthermore, in this system, the concept of timing out of data or of delay is not absolute and therefore does not make it possible to guarantee delays imposed by certain applications. For example, voice which “times out” rapidly.

Although they are effective, the various resource-allocation techniques in the prior art have a certain number of disadvantages:
they do not guarantee scheduling according to the real urgency of the data;
they do not support absolute classification according to the concepts of delay or timing out of data and therefore they do not make it possible to guarantee delays imposed by certain applications; and
they do not solve the problems of scheduling for highly variable and non deterministic traffic.

In the description, “node” or “station” means any network entity implemented in hardware or software that may be the input point or output point of an interchange or of a transmission of data or information between stations.

A request characterizes a requirement for resource, such as for example a slot, associated with an application or a class of service expressed by a network node to an allocation mechanism (the scheduler). A requirement may indicate notably a specification of end-to-end quality of service.

The invention relates to a method of allocating resources in a communication network comprising several nodes adapted to transmit and receive data and a central node adapted to allocated resources, characterized in that it comprises at least the following steps:
at least one node transmits one or more requests R_{nqt} to the central node, each request R_{nqt} being associated with a requirement qᵢ;
the central node allocates a lifetime Δt_{qi}, to each request R_{nqt} according to the requirement qᵢ of the request, and
each request R_{nqt} is scheduled in a queue according to the lifetime Δt_{qi} and the moment of receipt t_{R} of the request,
the first m requests R_{nqt} in the queue are retrieved for m available transmission moments,
the requests retrieved are scheduled per node n,
the distribution of the transmission moments is written in a signaling flag and then transmitted from the scheduler to the nodes.

In one embodiment of the invention, the lifetime may be allocated to a request according to the application associated with the request. So the requests associated with urgent or important applications may be placed at the beginning of the queue.

The lifetime may be allocated to a request according to a quality of service (QoS) associated with the request. This allows a classification of requests according to the quality of service of the associated application and makes it possible to comply with the priorities between the various quality of service levels. Therefore, high priority requests may be favored in the classification of the queue.

The lifetime may be allocated according to the time constraints of the application associated with the request or according to the time allowed for the transfer of the data associated with the request. This makes it possible to satisfy the most pressing requests and to supply scheduling reflecting the real urgency of the packets.

The network is for example an ad hoc network. The lifetime allocated to a request may depend on the number of network nodes that the data to be transmitted must pass through. This makes it possible to ensure transmission of the data from end to end of a network.

It is possible to use a TDMA protocol. Therefore, the resources to be allocated may be the moments of transmission.

In one embodiment for equal moments of expiration, the requests in the queue are scheduled according to the quality of service of the requests, a moment of expiration for a request being defined based on the lifetime allocated to the request and the moment of receipt of the request.

The method may comprise a step consisting in discriminating between the perishable requests and the nonperishable requests. The method may, for example, also comprise a step in which it is verified whether the requests are timed out, and the timed-out request(s) is (are) removed from the queue. This allows the management of timed-out data and hence makes it possible to respond to time constraints imposed by the services associated with the requests.

The checking of the requests may, for example, consist in comparing the moment of expiration of each request with the current moment and if the moment of expiration of a request is less than the current moment, the request is removed.

In another embodiment of the invention, each request is allocated a lifetime at the output and a comparison is made between a moment of expiration at the output, defined based on the lifetime at the output of the request, and the moment of receipt of the request, and the current moment. If the moment of expiration at the output of a request is less than the current moment, the request is removed.

The network is for example a wireless network.

In one embodiment, it is possible for the lifetime allocated to a request to be adjusted according to the priority or the time constraints associated with the request. This makes it possible to provide these requests with a competitive advantage in access to the resource since they will be systematically favored in the classification in the queue.

The invention also relates to a system for allocating resources in a communication network comprising several nodes suitable for transmitting and receiving data and a central node suitable for allocating resources, characterized in that several nodes are fitted with a processor capable of:
transmitting one or more requests R_{nqt} to the central node, each request R_{nqt} being associated with a requirement qᵢ, and in that the central node is fitted with a processor capable of:
allocating a lifetime Δt_{Q} to each request R_{nqt} received by the central node according to the requirement qᵢ of said request R_{nqt}; and
scheduling each request R_{nqt} received in a queue according to the lifetime Δt_{qi} and the moment of receipt t_{R} of said request R_{nqt},
the first m requests R_{nqt} in the queue are retrieved for m available transmission moments,
the retrieved requests are scheduled per node n,
the distribution of the transmission moments is written in a signaling flag and then transmitted from the scheduler to the nodes.

The method and the system for allocating resources according to the invention notably has the following advantages:
they make it possible to optimize the allocation of resources;
they allow an allocation that is fair between the nodes of a network;
they make it possible to satisfy the priorities of the services associated with the nodes;
they make it possible to provide guarantees of service in terms of bit rate and delay, whether it involves point-to-point or end-to-end transfers; and
they make it possible to take account of the time constraints of the data to be transmitted and ensure scheduling according to the real urgency of the data.

In addition, the data are not interlaced by priority or by flow but by real time constraints and therefore by their real degree of urgency. This interlacing is dependent on the data and not the flows, and is therefore naturally suitable to the “burst” and non-deterministic character of traffic such as voice, since it acts packet by packet.

Other features and advantages of the present invention will appear more clearly on reading the following description given as an illustration and being in no way limiting, with reference to the appended figures in which:

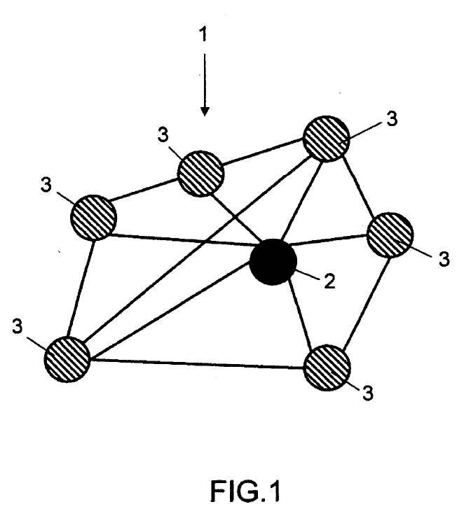

FIG. 1 schematizes an example of an ad hoc network with several nodes and a central node;

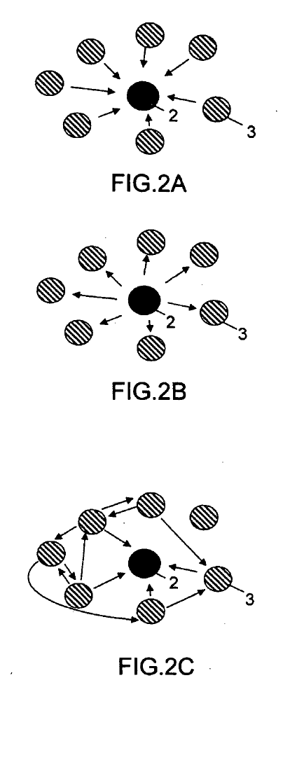

FIGS. 2A to 2C illustrate data interchanges in the network of FIG. 1;

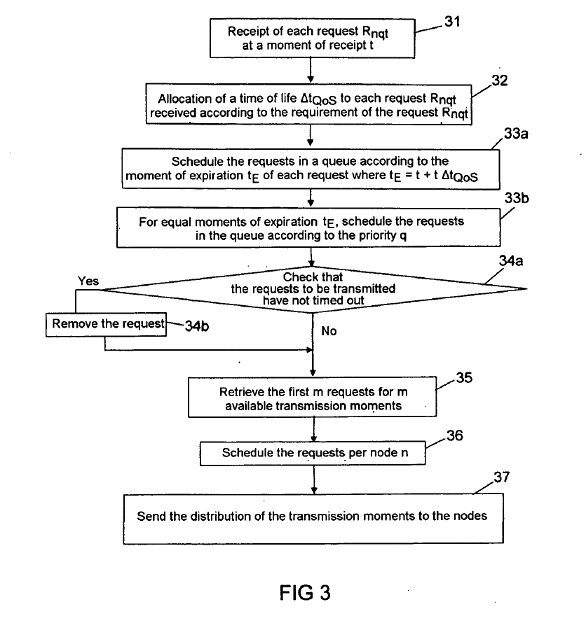

FIG. 3 details the steps of the method according to one embodiment of the invention;

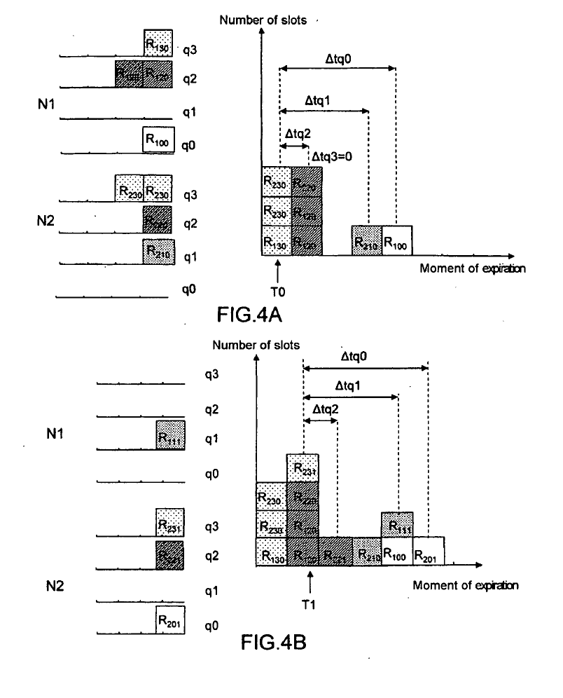

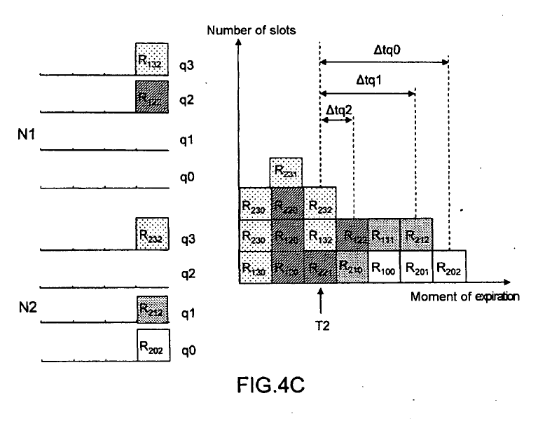

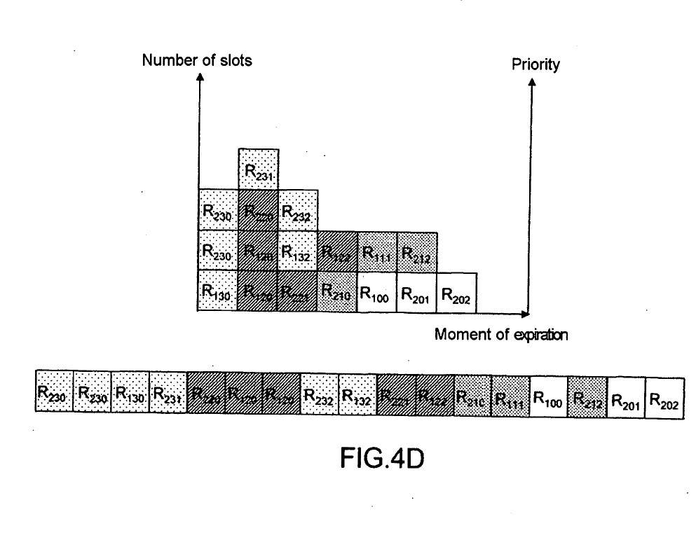

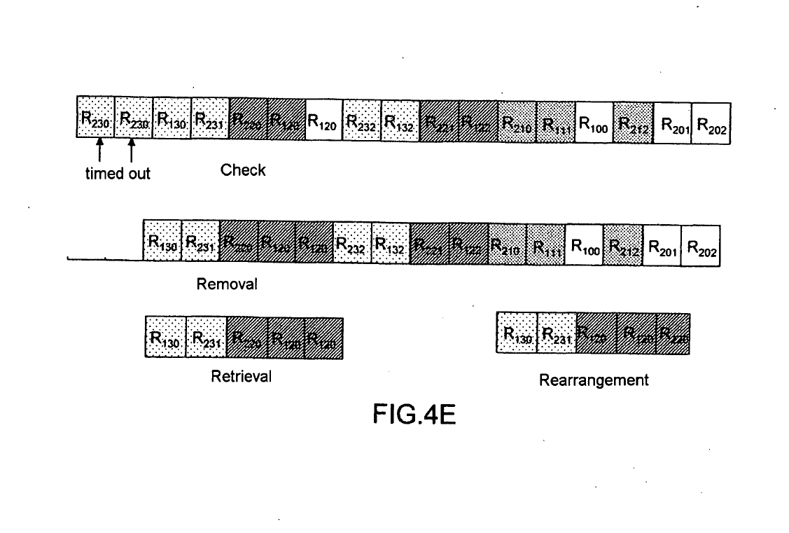

FIGS. 4A to E illustrate the method detailed in FIG. 3;

FIG. 5 illustrates a data checking step according to a variant of the invention; and

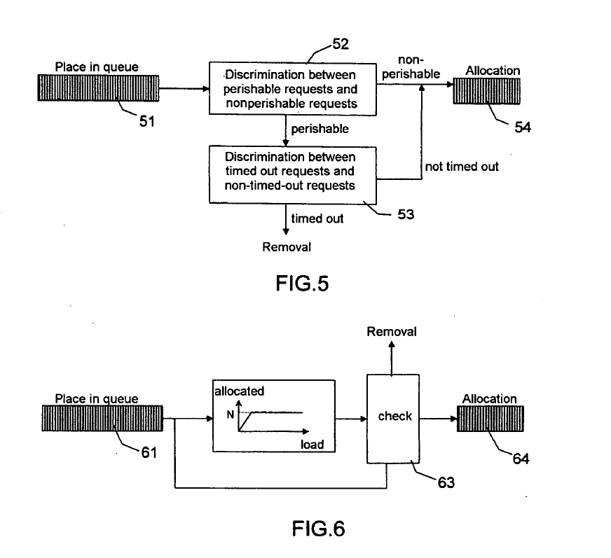

FIG. 6 illustrates a data checking step according to another variant of the invention.

In order to make the subject of the invention more comprehensible, the following example, given as an illustration, relates to an ad hoc communications network. FIG. 1 schematizes an example of an ad hoc network 1 operating on the TDMA (time division multiple access) principle. The network 1 comprises a central node 2 and a plurality of nodes 3 connected together and to the central node 2 by communication links. Each node 3 is fitted with transmit/receive means and is associated with a service or a user. The central node 2 is also fitted with transmit/receive means and plays the role of coordinator or “scheduler” of the network by allocating transmission moments to the nodes 3 according to their requirements q. The requirement q may correspond to a quality of service.

The nodes 3 may be mobile or non mobile, for example, microcomputers, wireless telephones, digital television sets. The communication links may be either wire links, or wireless links, for example, radio links.

It will be noted that the method according to the invention also applies for any other communication protocol.

FIGS. 2A to 2C illustrate in a general manner the data interchanges in the network of FIG. 1.

In a first step, illustrated in FIG. 2A, each node 3 transmits at least one request, in the form of a data packet containing the requests for transmission moments, to the scheduler 2. A request corresponds to a data packet that contains a request for a moment or some moments of transmission for a given node 3.

The requirements for transmission moments are specified in a two-dimensional space (Time and Importance, quality of service) originating from the applications associated with the nodes via a system=known per se for specifying the characteristics of a data stream, such as the use of the TOS “type of service” field of the IP packet header, the interpretation of the port of their TCP/UDP headers which indicates the corresponding application or the use of multiple queues.

Based on the requests received, the scheduler 2 determines the distribution of the transmission moments as will be explained below.

The scheduler 2 transmits to the nodes 3 the transmission moment distribution that has been defined, as shown in FIG. 2B.

The nodes 3 use the transmission moments that have been allocated to them for transmitting data packets to their intended recipient as illustrated in FIG. 2C.

FIGS. 3, 4A to 4C illustrate an example of the method of allocating transmission moments for the various nodes. This method comprises the following steps:

In a first step 31, the scheduler 2 receives requests for resources or requests R_{nqt} issued by the nodes 3 where n represents the node requesting the resource, q the quality of service (QoS) associated with this request R_{nqt} and t the moment of receipt of the request R_{nqt} by the scheduler 2. FIG. 4A illustrates a first series of requests R₁₃₀, R₁₂₀, R₁₂₀ R₁₀₀, R₂₃₀, R₂₃₀, R₂₂₀ and R₂₁₀ from two network nodes N1 and N2, the requests being classified according to their quality of service q0 to q3.

In a second step 32, the scheduler 2 allocates a lifetime Δt_{qi}, to each request R_{nqt}, according to the quality of service qi associated with the request R_{nqt}. The lifetime Δt_{qi} allocated to each request R_{nqt} is chosen, for example, according to the time constraints of the application associated with the request. FIG. 4A illustrates the allocation of the lifetime Δt_{qi} to the first series of requests received by the scheduler at a moment T0. To the requests associated with quality of service q3, a lifetime Δq3=0 is allocated, and to the requests associated with quality of service q2, q1 and q0 a lifetime Δq2, Δq1 and Δq0 is allocated respectively where Δq0>Δq1>Δq2. FIGS. 4B and 4C illustrate the allocation of the lifetimes associated with a second series of requests R₁₁₁, R₂₃₁ R₂₂₁, R₂₀₁ and a third series of requests R₁₃₂, R₁₂₂, R₂₃₂ R₂₁₂, R₂₀₂, received respectively by the scheduler at the times T1 and T2.

In a third step 33a, 33b, the scheduler 2 retrieves the requests R_{nqt} starting from the most pressing to the least pressing. It then schedules the requests R_{nqt} in a queue observing the moments of expiration of the requests as shown in FIG. 4D. The moment of expiration for a request R_{nqt} is defined by t+Δt_{qi}.

The order for two requests R_{n1q1t1} and R_{n2q2t2} having respectively a lifetime Δt_{q1} and Δt_{q2} is imposed by the following relation:

t₁+Δt_{q1}<t₂+Δt_{q2} [symbol] R_{n1,q1,t1}<R_{n2,q2,t2}

For the equal moments of expiration t+Δt_{q}, the requests are discriminated by qualities of service q associated with the requests. That is to say that it gives:

t₁+Δt_{q1}=t₂+Δt_{q2},q₁>q₂₁ [symbol] R_{n1,q1,t1}<R_{n2,q2,t2}

The highest qualities of service q (priorities increasing according to their importance) are then favored and placed in front, during the scheduling in the queue when the moments of expiration t+Δt_{qi} of the requests are equal. The method therefore provides a queue in which the high priority requests are favored, giving an order satisfying the real urgency of the requests.

In a fourth step 34a and 34b, a check is made that the requests R_{nqt} in the queue are not timed out. This checking step consists in comparing the current moment Tc with the moment of expiration t+Δt_{qi} of the request R_{nqt}. If the moment of expiration t+Δt_{qi} of the request R_{nqt} is less than the current moment Tc, the request R_{nqt} is removed from the queue as shown in FIG. 4E.

In a fifth step 35, the first m requests R_{nqt} in the queue are retrieved for m available transmission moments as illustrated in FIG. 4E.

In a sixth step 36, the retrieved requests are scheduled per node n as shown in FIG. 4E.

In a seventh step 37, the distribution of the transmission moments is written in a signaling flag and then transmitted from the scheduler to the nodes.

The method according to the invention described above may be carried out according to many variants. Therefore, according to certain variants, the method does not comprise the fourth step 34a and 34b of checking and removing the timed-out requests.

According to a variant of the invention, it is possible to refine or adjust the lifetime Δt_{qi} allocated to the requests. Accordingly, it is possible to reduce, or even nullify a lifetime Δt_{qi} for the applications with very high time constraints or high priority, for example voice. This makes it possible to give these requests a competitive advantage in access to the resource since they will be systematically favored in the classification in the queue.

According to another variant of the invention, the checking step consists in defining distinct constraints at the output from the constraints imposed for the scheduling of the list. For this, it is possible to allocate a lifetime at the output Δtₛᵢ to each request. Since the lifetime at the input Δt_{qi} aims, depending on the case, only at giving preference to the requests of such or such a priority or QoS, it does not always correspond to the real acceptable constraints. It is possible, for example, for the requests with very strong time constraints for which zero lifetimes have been imposed for scheduling (voice, for example), to authorize a margin at the output corresponding to the real acceptable lifetime in order to allow the allocation. In this case, the checking of the timed-out requests consists in comparing the moment of expiration at the output, defined based on the time of life at the output and the moment of receipt of the request, with the current moment. Therefore, the requests with a moment of expiration at the output that is less than the current moment will be removed from the queue.

In the case of data that must be transmitted whatever happens, such as for example the background traffic, the method may also comprise a step of discrimination between perishable requests and non-perishable requests.

FIG. 5 illustrates a variant of the invention in which the method comprises a step 52 of discrimination between perishable requests and nonperishable requests and a checking step 53 in which the perishable requests are then checked, according to one of the checking procedures described above, in order to check whether they are timed out or not. The non-timed-out and nonperishable requests, such as for example the requests associated with email, are kept in the queue 54 for the transmission of the allocation to the nodes.

FIG. 6 illustrates another variant of the invention in which the method comprises a checking step 63 in which the nonperishable requests are rearranged in the queue 61 and the timed-out requests are removed if there are no more transmission moments to be allocated. This makes it possible to manage queue congestion and to ensure the highest quality of service requests.

The step of checking the perishable and nonperishable requests may consist in allocating an artificial lifetime to the nonperishable requests. This lifetime is chosen, for example, according to the priority of the traffic, making it more or less competitive, but is not taken into account by the output check. The nonperishable requests are added to the requests allocated according to the order of time urgency without there being any check on their possible timing-out.

According to yet other variant embodiments, the lifetime may be allocated to each request or refined according to one or more of the following criteria: the application associated with the request, the time constraints associated with the application and/or the number of network nodes that the data must pass through.

This method may be interfaced with a “sessions” mechanism of the “connected mode type” MAC level or of the “RSVP type” network level that is capable of providing the characteristics of urgency and importance of the data to be transmitted.

Note that the method according to the invention may, without departing from the context of the invention, be applied to any other type of network and to propagation channels of any nature.

1. A method of allocating resources in a communication network (1) comprising several nodes (3) suitable for transmitting and receiving data and a central node (2) suitable for allocating resources, characterized in that it comprises at least the following steps:
at least one node (3) transmits one or more requests (R_{nqt}) to the central node (2), each request (R_{nqt}) being associated with a requirement (qᵢ);
the central node (2) allocates a lifetime (Δt_{qi}) to each request (R_{nqt}) according to the requirement (qᵢ) of the request, and
each request (R_{nqt}) is scheduled in a queue according to the lifetime (Δt_{qi}) and the moment of receipt (t_{R}) of the request,
the first m requests (R_{nqt}) in the queue are retrieved for m available transmission moments,
the requests retrieved are scheduled per node n,
the distribution of the transmission moments is written in a signaling flag and then transmitted from the scheduler to the nodes.

2. The method as claimed in claim 1, comprising allocating the lifetime (Δt_{qi}) to a request (R_{nqt}) according to the application associated with the request (R_{nqt}).

3. The method as claimed in claim 1, comprising allocating the lifetime (Δt_{qi}) to a request (R_{nqt}) according to a quality of service (QoS) associated with the request (R_{nqt}).

4. The method as claimed in claim 1, comprising allocating the lifetime (Δt_{qi}) to a request (R_{nqt}) depends on the number of network nodes that the data to be transmitted must pass through.

5. The method as claimed in claim 1, wherein a TDMA protocol is used and the resources to be allocated are the moments of transmission.

6. The method as claimed in claim 1, wherein for equal moments of expiration, the requests (R_{nqt}) in the queue are scheduled according to the quality of service (QoS) of the requests (R_{nqt}), a moment of expiration for a request being defined based on the lifetime (Δt_{qi}) allocated to the request (R_{nqt}) and the moment of receipt (t_{R}) of the request (R_{nqt}).

7. The method as claimed in claim 1, comprising a step consisting in discriminating between the perishable requests and the nonperishable requests.

8. The method claimed in claim 1, comprising a step in which it is verified whether the requests (R_{nqt}) are timed out, and the timed-out request(s) is (are) removed from the queue.

9. The method as claimed in claim 7, wherein the verification of the requests (R_{nqt}) includes comparing the moment of expiration of each request with the current moment and if the moment of expiration of a request is less than the current moment, the request (R_{nqt}) is removed.

10. The method as claimed in claim 8, wherein the verification of the requests includes (R_{nqt}) comparing the moment of expiration of each request with the current moment and if the moment of expiration of a request is less than the current moment, the request (R_{nqt}) is removed.

11. The method as claimed in claim 7, comprising allocating a lifetime to each request (R_{nqt}) at the output and a comparison is made between a moment of expiration at the output, defined based on the time of life at the output of the request (R_{nqt}), and the moment of receipt of the request (R_{nqt}) and the current moment and, if the moment of expiration at the output of a request (R_{nqt}) is less than the current moment, the request (R_{nqt}) is removed.

12. The method as claimed in claim 9, wherein a lifetime is allocated to each request (R_{nqt}) at the output and a comparison is made between a moment of expiration at the output, defined based on the time of life at the output of the request (R_{nqt}), and the moment of receipt of the request (R_{nqt}) and the current moment and, if the moment of expiration at the output of a request (R_{nqt}) is less than the current moment, the request (R_{nqt}) is removed.

13. The method as claimed in claim 1, wherein the network is a wireless network.

14. The method as claimed in claim 1, wherein the lifetime (Δt_{qi}) allocated to a request (R_{nqt}) can be adjusted according to the priority or the time constraints associated with the request (R_{nqt}).

15. A system for allocating resources in a communication network comprising several nodes suitable for transmitting and receiving data and a central node suitable for allocating resources, wherein several nodes are fitted with a processor capable of:
transmitting one or more requests (R_{nqt}) to the central node, each request (R_{nqt}) being associated with a requirement (qᵢ), and in that the central node is fitted with a processor capable of:
allocating a lifetime (Δt_{Q}) to each request (R_{nqt}) received by the central node according to the requirement (qᵢ) of said request (R_{nqt}); and
scheduling each request (R_{nqt}) received in a queue according to the lifetime (Δt_{qi}) and the moment of receipt (t_{R}) of said request (R_{nqt}),
the first m requests (R_{nqt}) in the queue are retrieved for m available transmission moments,
the retrieved requests are scheduled per node n,
the distribution of the transmission moments is written in a signaling flag and then transmitted from the scheduler to the nodes.

16. The system as claimed in claim 14, wherein the network is a wireless network.
